(19) United States
(12) Patent Application Publication
(10) Pub. No.: US 2026/0233322 A1
(43) Pub. Date: Aug. 13, 2026

(54) ARC WELDED JOINT AND METHOD FOR MANUFACTURING THE SAME

(71) Applicant: JFE Steel Corporation, Chiyoda-ku, Tokyo (JP)

(72) Inventors: Kyohei KONISHI, Chiyoda-ku (JP); Chikaumi SAWANISHI, Chiyoda-ku, Tokyo (JP); Koichi TANIGUCHI, Chiyoda-ku, Tokyo (JP)

(73) Assignee: JFE Steel Corporation, Chiyoda-ku, Tokyo (JP)

(21) Appl. No.: 19/474,864

(22) PCT Filed: Jan. 18, 2024
(86) PCT No.: PCT/JP2024/001190

§ 371 Date: Oct. 13, 2025

(30) Foreign Application Priority Data
Apr. 25, 2023 (JP) 2023-071307

(51) Int. Cl. B23K 9/025; B23K 9/073; B23K 9/09; B23K 103/04

(52) U.S. Cl. CPC B23K 9/025; B23K 9/073; B23K 9/091; B23K 2103/04

(57) ABSTRACT

An arc welded joint manufactured by lap fillet arc welding at a corner formed by two steel sheets, includes an upper sheet, a lower sheet, and a weld joining the upper sheet and the lower sheet. In the arc welded joint, the upper sheet and the lower sheet have a predetermined thickness; a lower sheet thickness t₂ and a penetration depth d, which is a distance from a boundary between the upper sheet and the lower sheet to a lower surface of a weld bead in a cross-section of the weld, satisfy a predetermined inequality; and a slag coverage area ratio S_{RATIO} calculated by a predetermined equation using a bead surface area S_{BEAD} of a weld bead surface and a slag surface area S_{SLAG}, which is an area of a region of the bead surface area S_{BEAD} covered with slag, is less than or equal to 15%.

### CROSS REFERENCE TO RELATED APPLICATIONS

This is the U.S. National Phase application of PCT/JP2024/001190, filed Jan. 18, 2024 which claims priority to Japanese Patent Application No. 2023-071307, filed Apr. 25, 2023, the disclosures of these applications being incorporated herein by reference in their entireties for all purposes.

### FIELD OF THE INVENTION

The present invention relates to an arc welded joint that has less slag adhesion amount, stable penetration depth, high welded joint strength, and high corrosion resistance at a weld, and also relates to a method for manufacturing the same.

### BACKGROUND OF THE INVENTION

In recent years, there has been a growing need for automobiles to have stronger and more rigid members for their bodies to improve safety and reliability of the bodies, as well as lighter members to improve fuel efficiency. Therefore, by using high-strength steel sheets, the thickness of steel sheets used as the members has been reduced. Of various members used in automobiles, suspension members (such as, for example, lower arms), in particular, use thicker steel sheets than those used in the bodies, from the perspective of member strength and rigidity. Therefore, when steel sheets used in the suspension members are made stronger and the thickness of the steel sheets is reduced, it will be possible to further reduce the weight of the automotive body. This improves fuel efficiency while ensuring member strength and rigidity.

Generally, members used in corrosive environments undergo anti-rust treatments, such as chemical conversion treatment and electrodeposition coating, after welding to ensure corrosion resistance. Over time, however, rust and corrosion may be observed at and near welds. In members that have undergone electrodeposition coating as described above, corrosion tends to start at welds. As time passes, while being accompanied by blistering of the coating, the corrosion spreads over a wider area at and around the welds and progresses in the thickness direction. As the corrosion progresses as described above, the sheet thickness at and near the welds decreases, and this results in a reduction in weld strength and consequently a reduction in the strength of the member. In other words, when corrosion occurs and progresses in a member (such as the suspension members of the automobile) that bears loads at welds, it may lead to member failure.

For electrodeposition coating, a chemical conversion treatment (such as zinc phosphate treatment) is first applied to the base steel sheet and the weld metal as a pretreatment, before electrodeposition coating, to enhance adhesion between the electrodeposited coating and both the base steel sheet and the weld metal. Zinc phosphate treatment, which is widely used as an example of chemical conversion treatment, is a technique that grows zinc phosphate crystals on the surfaces of the base steel sheet and weld metal to enhance adhesion of the electrodeposited coating. With conventional techniques, however, even in members that have undergone chemical conversion treatment before electrodeposition coating, there is a frequent occurrence of blistering of the coating in a wide area at and around welds over time. In other words, with techniques that perform electrodeposition coating after performing the above-described chemical conversion treatment as a pretreatment, it is difficult to completely suppress the occurrence of corrosion starting from welds.

When arc welding is performed on members using steel sheets with a coated layer, the coated layer evaporates at welds exposed to high heat from arc plasma (hereinafter referred to as arc) serving as a heat source, and uncoated areas are locally exposed. Therefore, a significant improvement in corrosion resistance that would justify the use of costly steel sheets with a coated layer cannot be expected.

As described above, although various manufacturing techniques have been developed to improve the corrosion resistance of members, they all have both advantages and disadvantages. From the perspective of improving corrosion resistance while controlling the increase in manufacturing costs, techniques are being investigated to more effectively prevent the occurrence and progression of corrosion starting at welds.

As starting points for corrosion from welds,
(a) slag adhering to the weld (mainly the surface of the weld bead);
(b) weld fumes adhering to the weld; and
(c) oxides formed on the surface of the steel sheet exposed to high temperatures during welding, have been conventionally known. Even when a member with the adhering substances in (a) and (b) or the oxides in (c) present on the weld undergoes chemical conversion treatment, these adhering substances and products serve as starting points for localized regions that remain uncoated with a chemical conversion coating composed of zinc phosphate crystals. Even when electrodeposition coating is applied to such regions, the formation of the coating is insufficient and this results in poor coating adhesion. As a consequence, corrosion resistance is significantly reduced, which leads to a reduced sheet thickness caused by the occurrence and progression of corrosion. The following are being investigated as techniques that prevent the formation of the adhering substances described in (a) and (b) and the oxides described in (c).

For example, Patent Literature 1 discloses a technique in which after arc welding and before electrodeposition coating, a weld and its vicinity are sprayed with or immersed in a non-oxidizing acidic solution having a pH of less than or equal to 2 and a temperature of 30° C. to 90° C. This technique removes the slag in (a), the weld fumes in (b), and the oxides in (c) by dissolving the weld bead and the base steel sheet with the non-oxidizing solution.

However, the technique disclosed in Patent Literature 1 requires the acidic solution to be rinsed off before electrodeposition coating, which complicates the process of manufacturing the member. Since a member formed into a desired shape is made by overlapping and joining steel sheets of various shapes, any residual acidic solution in gaps between the overlapping steel sheets may cause severe corrosion. Since the acidic solution is used in large quantities, the manufacturing equipment is exposed to a corrosive environment and this increases the possibilities of corrosion and malfunctions. Additionally, it is necessary to prevent the dispersion of fumes to ensure the safety of workers.

Patent Literature 2 discloses a technique in which the corrosion resistance of a weld and its vicinity after coating is improved by reducing the total Si content in the welding wire and the base material used in arc welding, and increasing the total Mn content in the welding wire and the base material.

However, when the Si content is reduced from the perspective of suppressing slag formation, the strength of the steel sheet inevitably decreases. In other words, the technique disclosed in Patent Literature 2 requires the use of thicker steel sheets to ensure the strength of members, and it is difficult to achieve weight reduction of the automotive body.

Patent Literature 3 discloses a technique in which a chemical conversion coating is effectively formed by adjusting the composition of the treatment solution used in the chemical conversion treatment, even on weld beads where slag, weld fumes, and oxides are present. Specifically, the formation of a chemical conversion coating is facilitated by performing surface treatment using a surface conditioning solution containing zinc phosphate colloid. Additionally, by performing chemical conversion treatment using a zinc phosphate treatment solution containing greater than or equal to 100 mass ppm of F, slag, weld fumes, and oxides are dissolved and removed to improve the adhesion of the coating formed by electrodeposition coating.

However, the technique disclosed in Patent Literature 3 uses a zinc phosphate treatment solution containing fluorine designated as a toxic substance. When the waste solution is discharged to the outside of the factory, the fluorine content is to be reduced to a level that meets environmental standards. Therefore, in addition to the equipment for manufacturing the members, large-scale waste treatment facilities are required.

### PATENT LITERATURE

PTL 1: Japanese Unexamined Patent Application Publication No. 9-20994
PTL 2: Japanese Unexamined Patent Application Publication No. 8-33997
PTL 3: Japanese Patent No. 5549615

### SUMMARY OF THE INVENTION

The present invention has been made in view of the problems described above. An object of the present invention is to provide an arc welded joint that has less slag adhesion amount, stable penetration depth, high welded joint strength, and high corrosion resistance at a weld, and to also provide a method for manufacturing the same.

The present inventors have found that the most effective way to improve corrosion resistance at a weld and stably obtain a welded joint having a stable penetration depth is to reduce slag adhering to the weld and achieve periodic short-circuiting transfer using pulsed welding.

To suppress the amount of slag formation at the weld, it is important to suppress oxidation of Si, Mn, Ti, and the like contained in the steel sheet and the welding wire. By using a shielding gas with less oxidizing gas content, the oxidation of these elements is suppressed and the amount of slag formation can be reduced. In gas-shielded arc welding with a high Ar gas ratio in the shielding gas, however, the arc tends to spread more widely. As a result, the heat flux to the base material decreases, and the penetration depth at the weld is shallow. After the cleaning action removes the oxide film on the steel sheet surface, the wandering of cathode spots over the steel sheet surface causes arc instability. This results in an unstable penetration depth. The present inventors have found a technique that uses pulsed welding to reduce the wandering of cathode spots and achieve periodic short-circuiting transfer less susceptible to arc fluctuations, and uses a pulsed current waveform to obtain a welded joint with less slag adhesion amount, stable penetration, high welded joint strength, and high corrosion resistance at a weld.

The present invention is based on the findings described above and is summarized as follows.
[1] An arc welded joint manufactured by lap fillet arc welding of joining a corner formed by two steel sheets includes an upper sheet, a lower sheet, and a weld joining the upper sheet and the lower sheet and penetrating into the upper sheet and the lower sheet. In the arc welded joint, an upper sheet thickness t₁ and a lower sheet thickness t₂ are both less than or equal to 5.0 mm; the lower sheet thickness t₂ and a penetration depth d, which is a distance from a boundary between the upper sheet and the lower sheet to a lower surface of a weld bead in a cross-section of the weld, satisfy the following inequality (1):

$$0.2 \leq d / {t}_{2} \leq 0.8 , \qquad ( 1 )$$

where, in inequality (1), t₂ (mm) is lower sheet thickness and d (mm) is penetration depth; and a slag coverage area ratio S_{RATIO} calculated by the following equation (2) using a bead surface area S_{BEAD} of a weld bead surface and a slag surface area S_{SLAG}, which is an area of a region of the bead surface area S_{BEAD} covered with slag, is less than or equal to 15%:

$${S}_{RATIO} = {S}_{SLAG} / {S}_{BEAD} \times 100 , \qquad ( 2 )$$

where, in equation (2), S_{BEAD} (mm²) is bead surface area, S_{SLAG} (mm²) is slag surface area being the area of the region covered with slag, and S_{RATIO} (%) is slag coverage area ratio.
[2] An arc welded joint manufacturing method for manufacturing an arc welded joint according to [1] includes performing pulsed welding that periodically repeats a pulse peak current and a pulse base current as arc welding. In the arc welded joint manufacturing method, an average welding current I_{AVE} is greater than or equal to 100 A and less than or equal to 320 A; a pulse peak current Iₚ is greater than or equal to 400 A and less than or equal to 600 A; a pulse peak time Tₚ is greater than or equal to 1.5 ms and less than or equal to 3.5 ms; a gas containing greater than or equal to 98 vol % Ar is used as a shielding gas during welding; and a droplet transfer is achieved by short-circuiting a welding wire and a base material.
[3] In the arc welded joint manufacturing method according to [2], in the pulsed welding, the pulse peak current Iₚ, a pulse base current I_{b}, the pulse peak time Tₚ, a rise time Tᵤₚ from pulse base current to pulse peak current, a fall time T_{down} from pulse peak current to pulse base current, an arc voltage V, and a welding speed W satisfy the following inequality (3):

$$5.8 \leq ( {I}_{p} \times ( {T}_{p} + {T}_{up} + {T}_{down} ) - ( {I}_{p} - {I}_{b} ) \times ( {T}_{up} + {T}_{down} ) / 2 ) / ( {T}_{p} + {T}_{u p} + {T}_{down} ) \times V / W / 10 \; 00 \leq 14.4 \qquad ( 3 )$$

where Iₚ (A) is pulse peak current, I_{b} (A) is pulse base current, Tₚ (ms) is pulse peak time, Tᵤₚ (ms) is rise time, T_{down} (ms) is fall time, V (V) is arc voltage, and W (cm/s) is welding speed.

The present invention achieves stable penetration to ensure high welded joint strength, and suppresses slag formation to provide a welded joint that has high corrosion resistance at a weld. Additionally, the advantageous effects described above can be achieved without making special changes to the specifications of welding equipment used in conventional carbon dioxide welding, MAG welding using mixtures of inert and active gases, or MIG welding using gasses mainly composed of inert gases.

### BRIEF DESCRIPTION OF DRAWINGS

FIG. 1 is a schematic diagram illustrating an example of a welded joint made by arc welding.

FIG. 2(a) and FIG. 2(b) are schematic diagrams illustrating droplet transfer in conventional arc welding.

FIG. 3(a) and FIG. 3(b) are schematic diagrams illustrating short-circuiting transfer in the present invention.

FIG. 4 is a schematic diagram illustrating a penetration depth and a throat thickness in a weld cross-section.

FIG. 5 is a schematic diagram illustrating a pulsed current waveform in arc welding according to the present invention.

FIG. 6 is a schematic diagram illustrating a bead area and a slag coverage area in a weld bead.

FIG. 7 is a schematic diagram illustrating a corrosion resistance test in the weld bead.

### DETAILED DESCRIPTION OF EMBODIMENTS OF THE INVENTION

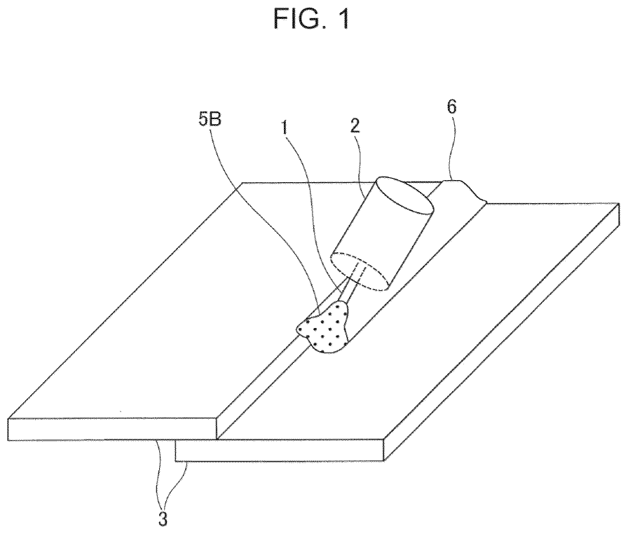

Hereinafter, details of the present invention will be described with reference to the drawings. FIG. 1 is a schematic diagram illustrating, as an exemplary embodiment of the present invention, an example of a welded joint made by arc welding. Although lap fillet arc welding at the corner formed by two steel sheets is illustrated as a representative example here, the welded joint shape and the welding position are not limited in the present invention.

In the present invention, as illustrated in FIG. 1, for example, a welding voltage is applied from a welding power source (not illustrated), with a welding wire 1, which is continuously fed from a welding torch 2 through the center of the welding torch 2 to a base material 3 (specifically, for example, a weld line defined by the corner of a step formed by two overlapping base materials 3), serving as the anode and the base material 3 serving as the cathode. A contact tip is installed in the welding torch 2. The contact tip supplies power to the welding wire 1 and serves as a feeding guide. An arc 5B is formed between the welding wire 1 and the base material 3, as part of Ar shielding gas (not illustrated) supplied through the welding torch 2 becomes ionized into plasma. Another part of the Ar shielding gas flowing from the welding torch 2 to the base material 3 without becoming ionized serves to shield the arc 5B and a molten pool (not illustrated in FIG. 1) formed by melting of the base material 3 from the outside air. Heat input from the arc 5B causes the tip of the welding wire 1 to melt and form a droplet, which is transported to the molten pool by electromagnetic force, gravity, and the like. This phenomenon continuously occurs as the welding torch 2 or the base material 3 moves, and the molten pool solidifies behind the weld line to form a weld bead 6. This completes the joining of at least two steel sheets (base materials 3).

When conventional MIG welding is performed on carbon steel to which the present invention is applicable, the welding is extremely unstable. In MAG welding or MIG welding, which is reverse polarity welding where the electrode (wire) serves as the anode, cathode spots are formed on the steel sheet surface of the base material starting from regions with low work function, such as oxides, where electron emission is likely to occur. For example, in aluminum alloys with a strong oxide film on the surface of the base material, cathode spots are stably formed starting from the oxide film on the weld line and this enables good welding. In contrast, in steels that do not readily have an oxide film, in MIG welding where oxides derived from O₂ or CO₂ are not produced, cathode spots are unstable and move violently around the surface of the base material in search of regions with low work function. This leads to unstable heat input into the base material, and results in a welded joint with an insufficient penetration depth or significant variation in penetration depth. Instability in welding may reduce the shielding performance of the Ar shielding gas that blocks entry of oxidizing gases into the molten pool, and may increase slag formation.

In response to this phenomenon, the present inventors observed arc behaviors in welding experiments and concluded that the main cause of the problems in MIG welding of carbon steel, such as insufficient penetration, unstable penetration, and increased slag formation described above, was unstable droplet transfer.

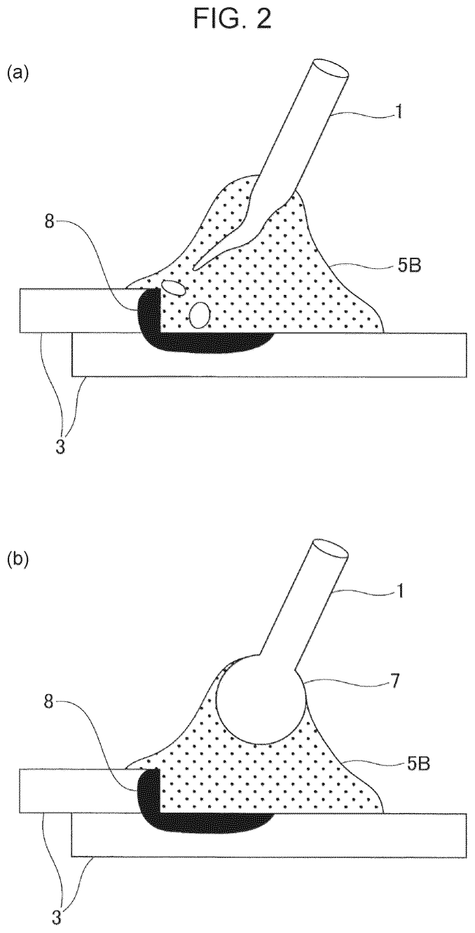

FIG. 2(a) and FIG. 2(b) are schematic diagrams illustrating droplet transfer in conventional MIG welding. Droplet transfer in conventional MIG welding involves a mixture of different modes: one in which the welding wire 1 melts and is continuously transported from an elongated liquid column to a molten pool 8 as illustrated in FIG. 2(a); and the other in which a large droplet 7 forms at the tip of the welding wire 1 and is transported to the molten pool 8 by falling or short-circuiting as illustrated in FIG. 2(b). To suppress this unstable droplet transfer, it is considered effective to regularly detach the droplet 7 from the tip of the welding wire 1. In the case of Ar shielding gas, however, the electromagnetic pinch force acting on the welding wire 1 is small and this makes it difficult to detach the droplet 7.

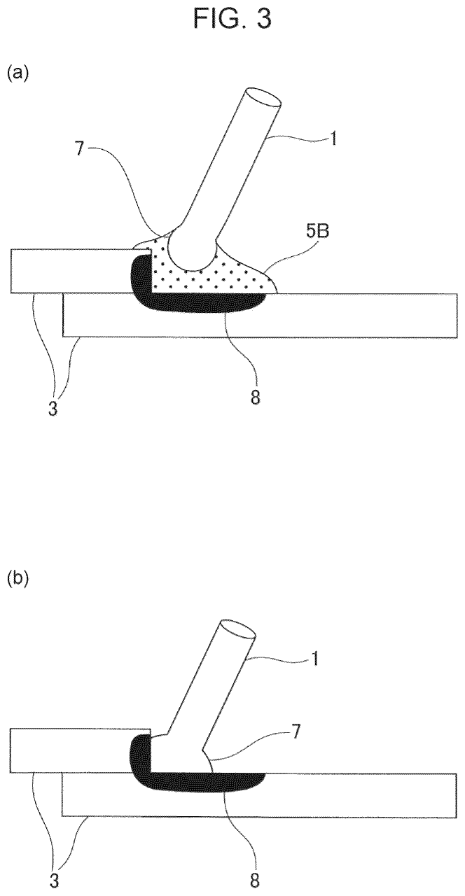

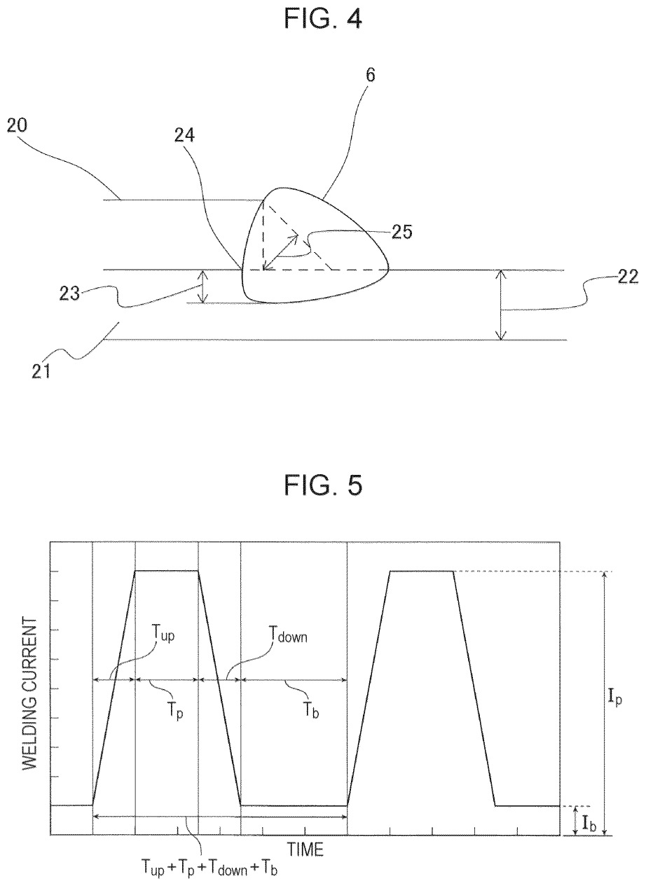

The present invention has found that an effective way of stabilizing droplet transfer is to complete the joining by so-called periodic short-circuiting transfer in which a non-short-circuiting state illustrated in FIG. 3(a) and a short-circuiting state illustrated in FIG. 3(b) are regularly repeated between the tip of the welding wire 1 and the base material 3, and the droplet 7 is transferred to the base material 3 in the short-circuiting state. Further welding experiments have revealed that by limiting the pulse peak current and the pulse peak time of a pulsed current waveform, the penetration depth in a weld cross-section, such as that illustrated in FIG. 4, can be controlled to a predetermined value, and a predetermined welded joint strength can be achieved.

FIG. 4 is a schematic diagram illustrating a penetration depth and a throat thickness in a weld cross-section. The arc welded joint includes an upper sheet 20, a lower sheet 21, and the weld bead 6 that joins the upper sheet 20 and the lower sheet 21 and penetrates into the upper sheet 20 and the lower sheet 21. A penetration depth 23 refers to the distance from a boundary 24 between the upper sheet 20 and the lower sheet 21 to the lower surface of the weld bead 6 in the weld cross-section. A lower sheet thickness t₂ is indicated by reference numeral 22.

### Lower Sheet Thickness t₂ and Penetration Depth d Satisfying Inequality (1)

$$0.2 \leq d / {t}_{2} \leq 0.8 \qquad ( 1 )$$

In inequality (1), t₂ (mm) is lower sheet thickness and d (mm) is penetration depth. When d/t₂ is less than 0.20, poor penetration occurs at the weld and the welded joint strength decreases. Therefore, d/t₂ is to be greater than or equal to 0.20, preferably greater than or equal to 0.25, more preferably greater than or equal to 0.30, even more preferably greater than or equal to 0.32, and most preferably greater than or equal to 0.35. When d/t₂ exceeds 0.80, excessive heat input during welding increases the area of a weld heat affected zone and causes a decrease in welded joint strength. Increased welding deformation may also make it difficult to obtain a predetermined welded joint strength. Therefore, d/t₂ is to be less than or equal to 0.80, preferably less than or equal to 0.75, more preferably less than or equal to 0.70, even more preferably less than or equal to 0.68, and most preferably less than or equal to 0.65.

Upper Sheet Thickness t₁ and Lower Sheet Thickness t₂: Less than or Equal to 5.0 mm

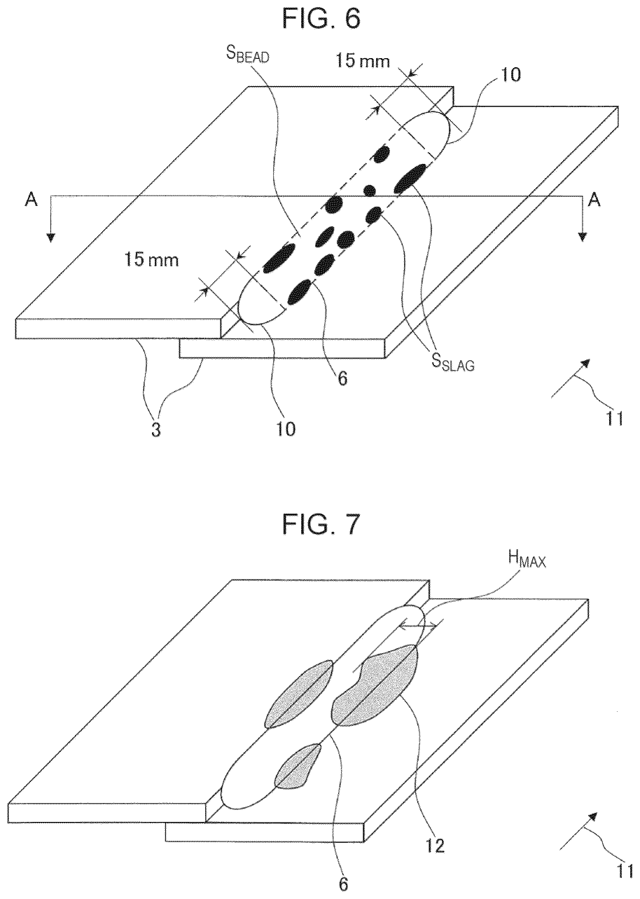

When the upper sheet thickness t₁ and the lower sheet thickness t₂ are greater than 5.0 mm, the diffusion of heat input causes insufficient penetration and reduces a throat thickness 25 illustrated in FIG. 4. This reduces the cross-sectional area (throat thickness×weld length) that bears external loads, and leads to reduced welded joint strength. Therefore, the upper sheet thickness t₁ and the lower sheet thickness t₂ are to be less than or equal to 5.0 mm. The upper sheet thickness t₁ and the lower sheet thickness t₂ are preferably less than or equal to 4.8 mm, more preferably less than or equal to 4.5 mm, even more preferably less than or equal to 4.2 mm, and most preferably less than or equal to 4.0 mm. The lower limit is not particularly defined, but the upper sheet thickness t₁ and the lower sheet thickness t₂ are preferably greater than or equal to 0.5 mm, more preferably greater than or equal to 0.8 mm, even more preferably greater than or equal to 1.0 mm, and most preferably greater than or equal to 1.2 mm. Note that the weld length refers to the length of the weld bead 6 in a weld line direction 11 illustrated in FIG. 6.

Slag Coverage Area Ratio S_{RATIO}: Less than or Equal to 15%

When a slag coverage area ratio S_{RATIO} calculated by the following equation (2) using a bead surface area S_{BEAD} of the weld bead surface and a slag surface area S_{SLAG}, which is the area of a region of the bead surface area S_{BEAD} covered with slag, exceeds 15%, rust and corrosion will progress over a wide area of the weld, starting from slag, and the welded joint strength may decrease due to a reduction in sheet thickness. Therefore, the slag coverage area ratio S_{RATIO} is to be less than or equal to 15%. The slag coverage area ratio S_{RATIO} is preferably less than or equal to 14%. The slag coverage area ratio S_{RATIO} is more preferably less than or equal to 12%. The slag coverage area ratio S_{RATIO} is even more preferably less than or equal to 10%. The slag coverage area ratio S_{RATIO} is most preferably less than or equal to 8%. The lower limit is not particularly defined and may be 0%.

$${S}_{RATIO} = {S}_{SLAG} / {S}_{BEAD} \times 100 \qquad ( 2 )$$

In equation (2), S_{BEAD} (mm²) is bead surface area, S_{SLAG} (mm²) is slag surface area which is the area of region covered with slag, and S_{RATIO} (%) is slag coverage area ratio.

A method for manufacturing an arc welded joint will now be described.

Pulsed Welding with Average Welding Current I_{AVE} Greater than or Equal to 100 A and Less than or Equal to 320 A

FIG. 5 is a schematic diagram illustrating a pulsed current waveform in arc welding according to the present invention. Pulsed welding refers to a welding technique that periodically repeats a pulse peak current (Iₚ) and a pulse base current (I_{b}). An average welding current I_{AVE} is the time average of welding current that periodically changes as shown in the pulse waveform in FIG. 5. In pulsed welding with an average welding current I_{AVE} of less than 100 A, instability of MIG arc cannot be suppressed, and a predetermined penetration depth cannot be achieved. Therefore, the average welding current I_{AVE} is to be greater than or equal to 100 A. The average welding current I_{AVE} is preferably greater than or equal to 120 A. The average welding current I_{AVE} is more preferably greater than or equal to 140 A. The average welding current I_{AVE} is even more preferably greater than or equal to 160 A. The average welding current I_{AVE} is most preferably greater than or equal to 180 A. In pulsed welding with an average welding current I_{AVE} exceeding 320 A, the resulting excessive heat input may cause burn-through, which is a welding defect. Therefore, the average welding current I_{AVE} is to be less than or equal to 320 A. The average welding current I_{AVE} is preferably less than or equal to 300 A. The average welding current I_{AVE} is more preferably less than or equal to 270 A. The average welding current I_{AVE} is even more preferably less than or equal to 260 A. The average welding current I_{AVE} is most preferably less than or equal to 250 A.

Pulse Peak Current Iₚ: Greater than or Equal to 400 A and Less than or Equal to 600 A

When the pulse peak current Iₚ is less than 400 A, the heat input is insufficient and this leads to a reduced penetration depth. Therefore, the pulse peak current Iₚ is to be greater than or equal to 400 A. The pulse peak current Iₚ is preferably greater than or equal to 450 A. The pulse peak current Iₚ is more preferably greater than or equal to 470 A. The pulse peak current Iₚ is even more preferably greater than or equal to 490 A. The pulse peak current Iₚ is most preferably greater than or equal to 500 A. When the pulse peak current Iₚ is greater than 600 A, the resulting excessive instantaneous heat input may cause burn-through, which is a welding defect. The occurrence of burn-through, which is a welding defect, means that the base materials are not properly joined and a predetermined arc welded joint cannot be obtained. Therefore, the pulse peak current Iₚ is to be less than or equal to 600 A. The pulse peak current Iₚ is preferably less than or equal to 590 A. The pulse peak current Iₚ is more preferably less than or equal to 580 A. The pulse peak current Iₚ is even more preferably less than or equal to 570 A. The pulse peak current Iₚ is most preferably less than or equal to 560 A.

When the pulse base current (I_{b}) is too small, arc discharge during the base period is unstable, and this may result in deterioration of the bead shape and insufficient penetration. Therefore, the pulse base current (I_{b}) is preferably greater than or equal to 30 A. The pulse base current (I_{b}) is more preferably greater than or equal to 40 A. The pulse base current (I_{b}) is even more preferably greater than or equal to 45 A. The pulse base current (I_{b}) is most preferably greater than or equal to 50 A. On the other hand, when the pulse base current (I_{b}) is excessively large, it may cause burn-through. Additionally, since the difference between the pulse peak current (Iₚ) and the pulse base current (I_{b}) is not large enough, the action of pushing the droplet 7 at the tip of the welding wire 1 down into the molten pool 8 for short-circuiting will be insufficient, and this may result in unstable welding. Therefore, the pulse base current (I_{b}) is preferably less than or equal to 120 A. The pulse base current (I_{b}) is more preferably less than or equal to 110 A. The pulse base current (I_{b}) is even more preferably less than or equal to 100 A. The pulse base current (I_{b}) is most preferably less than or equal to 90 A.

Pulse Peak Time Tₚ: Greater than or Equal to 1.5 ms and Less than or Equal to 3.5 ms

When the pulse peak time Tₚ is less than 1.5 ms, the heat input is insufficient, as in the case of the pulse peak current, and this leads to a reduced penetration depth. Therefore, the pulse peak time Tₚ is to be greater than or equal to 1.5 ms. The pulse peak time Tₚ is preferably greater than or equal to 1.8 ms. The pulse peak time Tₚ is more preferably greater than or equal to 2.0 ms. The pulse peak time Tₚ is even more preferably greater than or equal to 2.1 ms. When the pulse peak time Tₚ exceeds 3.5 ms, the resulting excessive heat input may cause burn-through, which is a welding defect. Therefore, the pulse peak time Tₚ is to be less than or equal to 3.5 ms. The pulse peak time Tₚ is preferably less than or equal to 3.2 ms. The pulse peak time Tₚ is more preferably less than or equal to 3.0 ms. The pulse peak time Tₚ is even more preferably less than or equal to 2.9 ms. The pulse peak time Tₚ is more preferably less than or equal to 2.8 ms.

Pulse Peak Current Iₚ and Pulse Base Current I_{b}, Pulse Peak Time Tₚ, Rise Time Tᵤₚ from Pulse Base Current to Pulse Peak Current, Fall Time T_{down} from Pulse Peak Current to Pulse Base Current, Arc Voltage V, and Welding Speed W Satisfying the Following Inequality (3) (Preferred Condition)

$$5.8 \leq ( {I}_{p} \times ( {T}_{p} + {T}_{up} + {T}_{down} ) - ( {I}_{p} - {I}_{b} ) \times ( {T}_{up} + {T}_{down} ) / 2 ) / ( {T}_{p} + {T}_{u p} + {T}_{down} ) \times V / W / 10 \; 00 \leq 14.4 \qquad ( 3 )$$

In inequality (3), Iₚ (A) is pulse peak current, I_{b} (A) is pulse base current, Tₚ (ms) is pulse peak time, Tᵤₚ (ms) is rise time, T_{down} (ms) is fall time, V (V) is arc voltage, and W (cm/s) is welding speed.

When (Iₚ×(Tₚ+Tᵤₚ+T_{down})−(Iₚ−I_{b})×(Tᵤₚ+T_{down})/2)/(Tₚ+Tᵤₚ+T_{down})× V/W/1000 is less than 5.8 kJ/cm, the heat input at the peak time, which affects penetration, is too small, and the penetration depth 23 decreases. Therefore, (Iₚ×(Tₚ+Tᵤₚ+T_{down})−(Iₚ−I_{b})×(Tᵤₚ+T_{down})/2)/(Tₚ+Tᵤₚ+T_{down})×V/W/1000 is preferably greater than or equal to 5.8 kJ/cm, more preferably greater than or equal to 6.5 kJ/cm, even more preferably greater than or equal to 7.0 kJ/cm, and most preferably greater than or equal to 7.5 kJ/cm. When (Iₚ×(Tₚ+Tᵤₚ+T_{down})−(Iₚ−I_{b})×(Tᵤₚ+T_{down})/2)/(Tₚ+Tᵤₚ+T_{down})×V/W/1000 exceeds 14.4 kJ/cm, the resulting excessive heat input may cause burn-through, which is a welding defect. Therefore, (Iₚ×(Tₚ+Tᵤₚ+T_{down})−(Iₚ−I_{b})×(Tᵤₚ+T_{down})/2)/(Tₚ+Tᵤₚ+T_{down})×V/W/1000 is preferably less than or equal to 14.4 kJ/cm, more preferably less than or equal to 12.8 kJ/cm, even more preferably less than or equal to 11.5 kJ/cm, and most preferably less than or equal to 10.2 kJ/cm.

Using Gas Containing Greater than or Equal to 98 Vol % Ar as Shielding Gas

When the Ar gas ratio in the shielding gas is less than 98 vol %, chemical reactions between oxidizing gases in the shielding gas and alloy elements contained in the molten metal are promoted. This increases slag formation that leads to reduced corrosion resistance. Therefore, the Ar gas ratio in the shielding gas is to be greater than or equal to 98 vol %. The Ar gas ratio in the shielding gas is preferably greater than or equal to 99 vol %. The upper limit is not particularly defined and the Ar gas ratio may be 100%.

The welding wire 1 used in the present invention is not particularly limited. For example, a solid wire for MAG welding as specified in JIS Z 3312 can be used.

The base material 3 according to the present invention is applicable to steel sheets and coated steel sheets. The chemical composition of the steel sheet is not limited, but a steel sheet containing, for example, C: 0.02 to 0.3 mass %, Si: greater than or equal to 0.01 mass %, Mn: greater than or equal to 0.5 mass %, P: less than or equal to 0.05 mass %, and S: less than or equal to 0.05 mass % is preferable. The steel sheet may further contain alloy elements, such as Cu, Ni, Cr, and Ti. The Si content in the steel sheet is preferably less than or equal to 3.0 mass %, and the Mn content in the steel sheet is preferably less than or equal to 5.0 mass %. The lower limit of P is not particularly defined, but is preferably greater than or equal to 0.0005 mass %. The lower limit of S is not particularly defined, but is preferably greater than or equal to 0.0005 mass %. Although the composition of the coating of the coated steel sheet is not particularly limited, the coating may contain, for example, Zn.

### Examples

Hereinafter, Examples of the present invention will be described. Fillet welding was performed on two overlapping steel sheets (two steel sheets were of the same thickness) having the composition shown in Table 1, for example, by the method illustrated in FIG. 1. The steel sheets contain Fe and alloy elements, such as, Cu, Ni, Cr, and Ti, other than the components shown in Table 1. Welding was performed under the welding conditions shown in Table 2. A solid wire for MAG welding as specified in JIS Z 3312 was used as the welding wire.

The welded steel sheets obtained as described above were evaluated for slag coverage area ratio, penetration depth, corrosion resistance of the weld, and welded joint strength in accordance with the following test method.

### (Slag Coverage Area Ratio)

FIG. 6 is a schematic diagram illustrating a bead area and a slag coverage area in a weld bead. The bead surface area S_{BEAD} and the slag coverage surface area S_{SLAG}, such as those illustrated in FIG. 6, are calculated by photographing the surface of the region of the weld bead 6 excluding bead start and end portions 10 (each 15 mm long) from directly above, and measuring the projected area of the weld bead 6 and slag from the upper surface. When the length of the weld bead 6 is less than 130 mm, the surface of the entire region excluding the bead start and end portions 10 is photographed. When the length of the weld bead 6 is greater than or equal to 130 mm, the surface of any part (100 mm long) of the region excluding the bead start and end portions 10 is photographed. The slag coverage area ratio S_{RATIO} was determined by dividing the value of the calculated slag surface area S_{SLAG} by the value of the bead surface area S_{BEAD}. S_{RATIO} was considered acceptable when it was less than or equal to 15%.

### (Penetration Depth)

The penetration depth d was measured, in the region of the weld bead 6 excluding the bead start and end portions 10 (each 15 mm long), by observing a cross-section in the thickness direction perpendicular to the weld line (or parallel to straight line AA in FIG. 6) at any five points of the weld bead 6 as illustrated in FIG. 4. Note that the five points were spaced at least 5 mm apart from each other. Here, the weld bead 6 was cut in the thickness direction perpendicular to the weld line at any points, the penetration depth 23 was determined at each of the points, and the average value of them was defined as “penetration depth d (mm)”. When d/t₂ (where t₂ is lower sheet thickness) was greater than or equal to 0.20 and less than or equal to 0.80, it was considered acceptable.

### (Evaluation Result of Corrosion Resistance)

FIG. 7 is a schematic diagram illustrating a corrosion resistance test in the weld bead. After a corrosion test, arc welded joints were immersed in an immersion-type remover to remove the electrodeposition coating, and corrosion products were removed in accordance with ISO 8407. Then, when the bead start and end portions 10 (each 15 mm long) of the weld bead 6 were included, the surface of the region excluding the bead start and end portions 10 was photographed, and the resulting photographs were analyzed to measure, in a corrosion region 12, a maximum corrosion width H_{MAX} from a weld bead toe in a direction perpendicular to the weld line direction 11. When the length of the weld bead 6 was less than 130 mm, the surface of the entire region excluding the bead start and end portions 10 was photographed. When the length of the weld bead 6 was greater than or equal to 130 mm, the surface of any part (100 mm long) of the region excluding the bead start and end portions 10 was photographed. The corrosion resistance was rated as good and marked with “∘” when the maximum corrosion width H_{MAX} was less than 6.0 mm, and rated as poor and marked with “x” when the maximum corrosion width H_{MAX} was greater than or equal to 6.0 mm.

### (Evaluation Result of Welded Joint Strength)

First, tensile test pieces as specified in JIS Z 2241 were obtained from the welded joint by machining. The tensile test pieces were each prepared, with the weld in the center. A tensile test was performed on the prepared tensile test pieces at room temperature at a tensile speed of 10 mm/min to obtain a joint tensile strength. A value obtained by dividing the joint tensile strength by the tensile strength of the base material (simply referred to as strength ratio here) was used as an evaluation parameter for the welded joint strength. The welded joint strength was rated as excellent and marked with “⊚” when the strength ratio was greater than or equal to 0.6, rated as good and marked with “∘” when the strength ratio was greater than or equal to 0.5 and less than 0.6, and rated as poor and marked with “x” when the strength ratio was less than 0.5.

As can be seen in Table 2, under welding conditions Nos. 1 to 6 and Nos. 12 to 17 shown as Inventive Examples, welded joints with high corrosion resistance and high welded joint strength were obtained, as S_{RATIO} was less than or equal to 15% and d/t₂ was greater than or equal to 0.20 and less than or equal to 0.80.

Under welding conditions Nos. 1 to 4 and Nos. 12 to 14 of Inventive Examples described above, welded joints with higher corrosion resistance and higher welded joint strength were obtained, as S_{RATIO} was less than or equal to 15% and d/t₂ was greater than or equal to 0.30 and less than or equal to 0.70.

In contrast, under welding conditions Nos. 7 to 11 shown as Comparative Examples, welded joints with good properties were not obtained, as S_{RATIO} was greater than 15% or d/t₂ was less than 0.20 or greater than 0.80.

In Table 2, rating A was given when “S_{RATIO} was less than or equal to 15%, d/t₂ was greater than or equal to 0.30 and less than or equal to 0.70, and welded joint strength was ‘⊚’”, rating B was given when “S_{RATIO} was less than or equal to 15% and d/t₂ was greater than or equal to 0.20 and less than 0.30, or S_{RATIO} was less than or equal to 15%, d/t₂ was greater than 0.70 and less than or equal to 0.80, and welded joint strength was ‘∘’”, and rating F was given when “S_{RATIO} was greater than 15%, d/t₂ was less than 0.20 or greater than 0.80, or welded joint strength was ‘x’”. Rating F was considered a fail, and ratings A and B were considered a pass.

TABLE 1
Composition of Steel Sheet (mass %)

| C | Si | Mn | P | S |
|---|---|---|---|---|
| 0.060 | 0.71 | 1.80 | 0.0060 | 0.0010 |

TABLE 2

| | Parameters | | | | | | | | | |
|---|---|---|---|---|---|---|---|---|---|---|
| | | | | Average | | Pulse | Pulse | Pulse | | |
| Welding | | | Wire | Welding | Arc | Peak | Base | Peak | Rise | Fall |
| Conditions | Shielding | | Diameter | Current | Voltage | Current | Current | Time | Time | Time |
| No. | Gas | Wire | (mm) | (A) | (V) | (A) | (A) | (ms) | (ms) | (ms) |
| 1 | 100%Ar | JIS Z3312 G 78 A 4 | 1.2 | 216 | 24.7 | 500 | 50 | 1.5 | 1.0 | 1.0 |
| | | M N5CM3T | | | | | | | | |
| 2 | 100%Ar | JIS Z3312 G 78 A 4 | 1.2 | 223 | 24.1 | 600 | 80 | 2.0 | 1.0 | 1.0 |
| | | M N5CM3T | | | | | | | | |
| 3 | 100%Ar | JIS Z3312 G 78 A 4 | 1.2 | 234 | 23.5 | 450 | 50 | 2.0 | 1.0 | 1.0 |
| | | M N5CM3T | | | | | | | | |
| 4 | 100%Ar | JIS Z3312 G 49 AP 3 | 1.0 | 215 | 25.4 | 550 | 50 | 2.5 | 1.0 | 1.0 |
| | | M 16 | | | | | | | | |
| 5 | 100%Ar | JIS Z3312 G 78 A 4 | 1.2 | 208 | 24.6 | 400 | 80 | 1.5 | 1.0 | 1.0 |
| | | M N5CM3T | | | | | | | | |
| 6 | 100%Ar | JIS Z 3312 G59 JA 1 | 1.4 | 250 | 26.4 | 550 | 50 | 3.0 | 0.5 | 0.5 |
| | | UM 3M1T | | | | | | | | |
| 7 | 100%Ar | JIS Z3312 G 78 A 4 | 0.9 | 205 | 20.0 | 350 | 30 | 1.0 | 1.0 | 1.0 |
| | | M N5CM3T | | | | | | | | |
| 8 | 100%Ar | JIS Z3312 G 78 A 4 | 1.2 | 210 | 20.2 | - | - | - | - | - |
| | | M N5CM3T | | | | | | | | |
| 9 | 95%Ar + 5 | JIS Z3312 G 78 A 4 | 1.2 | 194 | 20.5 | 450 | 50 | 1.5 | 1.0 | 1.0 |
| | % CO2 | M N5CM3T | | | | | | | | |
| 10 | 100%Ar | JIS Z 3312 G59 JA 1 | 1.2 | 271 | 26.1 | 650 | 80 | 2.5 | 1.0 | 1.0 |
| | | UM 3M1T | | | | | | | | |
| 11 | 100% Ar | JIS Z3312 G 78 A 4 | 1.2 | 257 | 26.3 | 550 | 50 | 2.5 | 1.0 | 1.0 |
| | | M N5CM3T | | | | | | | | |
| 12 | 98% Ar + 2 | JIS Z3312 G 78 A 4 | 1.2 | 208 | 22.5 | 450 | 50 | 2.0 | 0.5 | 1.0 |
| | % CO2 | M N5CM3T | | | | | | | | |
| 13 | 100% Ar | JIS Z3312 G 78 A 4 | 1.2 | 231 | 26.7 | 600 | 50 | 2.5 | 0.5 | 0.5 |
| | | M N5CM3T | | | | | | | | |
| 14 | 100% Ar | JIS Z3312 G 78 A 4 | 1.2 | 197 | 23.2 | 450 | 80 | 1.5 | 1.0 | 1.0 |
| | | M N5CM3T | | | | | | | | |
| 15 | 98% Ar + 2 | JIS Z3312 G 78 A 4 | 1.0 | 185 | 21.3 | 400 | 50 | 1.5 | 0.5 | 0.5 |
| | % CO2 | M N5CM3T | | | | | | | | |
| 16 | 100% Ar | JIS Z3312 G 78 A 4 | 1.0 | 117 | 20.1 | 400 | 50 | 1.5 | 0.5 | 1.0 |
| | | M N5CM3T | | | | | | | | |
| 17 | 100% Ar | JIS Z3312 G 78 A 4 | 1.2 | 311 | 23.0 | 550 | 80 | 2.5 | 1.0 | 1.0 |
| | | M N5CM3T | | | | | | | | |
| | | | | | Evaluation Result | | | | | |
| Welding | Welding | Sheet | Penetration | Inequality | | | | Welded | | |
| Conditions | Speed | Thickness t2 | Depth d | (3) | SRATIO | | Corrosion | Joint | | |
| No. | (cm/s) | (mm) | (mm) | (kJ/cm) | (%) | d/t2 | Resistance | Strength | Rating | Remarks |
| 1 | 1.167 | 2.0 | 0.846 | 7.86 | 1 | 0.42 | ○ | ⊚ | A | Inventive Example |
| 2 | 1.167 | 2.6 | 1.307 | 9.71 | 6 | 0.50 | ○ | ⊚ | A | Inventive Example |
| 3 | 1.167 | 2.6 | 0.792 | 7.05 | 1 | 0.30 | ○ | ⊚ | A | Inventive Example |
| 4 | 1.167 | 2.6 | 1.080 | 9.55 | 2 | 0.42 | ○ | ⊚ | A | Inventive Example |
| 5 | 1.333 | 2.6 | 0.682 | 5.69 | 3 | 0.26 | ○ | ○ | B | Inventive Example |
| 6 | 0.833 | 2.6 | 1.854 | 15.45 | 6 | 0.71 | ○ | ○ | B | Inventive Example |
| 7 | 1.167 | 2.6 | 0.495 | 4.17 | 2 | 0.19 | ○ | × | F | Comparative Example |
| 8 | 1.167 | 2.3 | 0.384 | - | 11 | 0.17 | ○ | × | F | Comparative Example |
| 9 | 1.167 | 2.6 | 1.253 | 5.90 | 17 | 0.48 | × | ⊚ | F | Comparative Example |
| 10 | 0.833 | 2.0 | 1.694 | 16.40 | 5 | 0.85 | ○ | × | F | Comparative Example |
| 11 | 1.167 | 6.2 | 0.947 | 9.89 | 3 | 0.15 | ○ | × | F | Comparative Example |
| 12 | 1.167 | 2.3 | 0.841 | 7.02 | 10 | 0.37 | ○ | ⊚ | A | Inventive Example |
| 13 | 1.000 | 2.6 | 1.754 | 13.92 | 4 | 0.67 | ○ | ⊚ | A | Inventive Example |
| 14 | 1.333 | 2.6 | 0.749 | 5.99 | 2 | 0.29 | ○ | ⊚ | A | Inventive Example |
| 15 | 1.167 | 2.6 | 0.574 | 6.02 | 13 | 0.22 | ○ | ○ | B | Inventive Example |
| 16 | 0.833 | 2.0 | 0.511 | 7.54 | 8 | 0.26 | ○ | ○ | B | Inventive Example |
| 17 | 1.000 | 2.6 | 1.827 | 10.25 | 7 | 0.71 | ○ | ○ | B | Inventive Example |

### REFERENCE SIGNS LIST

1 welding wire
2 welding torch
3 base material
5B arc
6 weld bead
7 droplet
8 molten pool
10 bead start and end portions
11 weld line direction
12 corrosion region
20 upper sheet
21 lower sheet
22 lower sheet thickness
23 penetration depth
24 boundary between upper sheet and lower sheet in weld cross-section
25 throat thickness
Tᵤₚ rise time
Tₚ pulse peak time
T_{down} fall time
T_{b} pulse base current time
Tᵤₚ+Tₚ+T_{down}+T_{b} one pulse period
S_{BEAD} bead surface area
S_{SLAG} slag coverage surface area
H_{MAX} maximum corrosion width

1. An arc welded joint manufactured by lap fillet arc welding of joining a corner formed by two steel sheets, the arc welded joint comprising:
an upper sheet;
a lower sheet; and
a weld joining the upper sheet and the lower sheet and penetrating into the upper sheet and the lower sheet,
wherein an upper sheet thickness t₁ and a lower sheet thickness t₂ are both less than or equal to 5.0 mm;
the lower sheet thickness t₂ and a penetration depth d satisfy the following inequality (1), the penetration depth d being a distance from a boundary between the upper sheet and the lower sheet to a lower surface of a weld bead in a cross-section of the weld:
$$0.2 \leq d / {t}_{2} \leq 0.8 , \qquad ( 1 )$$
where, in inequality (1), t₂ (mm) is lower sheet thickness and d (mm) is penetration depth; and
a slag coverage area ratio S_{RATIO} calculated by the following equation (2) using a bead surface area S_{BEAD} of a weld bead surface and a slag surface area S_{SLAG} is less than or equal to 15%, the slag surface area S_{SLAG} being an area of a region of the bead surface area S_{BEAD} covered with slag:
$${S}_{RATIO} = {S}_{SLAG} / {S}_{BEAD} \times 100 , \qquad ( 2 )$$
where, in equation (2), S_{BEAD} (mm²) is bead surface area, S_{SLAG} (mm²) is slag surface area being the area of the region covered with slag, and S_{RATIO} (%) is slag coverage area ratio.

2. An arc welded joint manufacturing method for manufacturing an arc welded joint according to claim 1, the method comprising:
performing pulsed welding that periodically repeats a pulse peak current and a pulse base current as arc welding,
wherein an average welding current I_{AVE} is greater than or equal to 100 A and less than or equal to 320 A;
a pulse peak current Iₚ is greater than or equal to 400 A and less than or equal to 600 A;
a pulse peak time Tₚ is greater than or equal to 1.5 ms and less than or equal to 3.5 ms;
a gas containing greater than or equal to 98 vol % Ar is used as a shielding gas during welding; and
a droplet transfer is achieved by short-circuiting a welding wire and a base material.

3. The arc welded joint manufacturing method according to claim 2, wherein in the pulsed welding, the pulse peak current Iₚ, a pulse base current I_{b}, the pulse peak time Tₚ, a rise time Tᵤₚ from pulse base current to pulse peak current, a fall time T_{down} from pulse peak current to pulse base current, an arc voltage V, and a welding speed W satisfy the following inequality (3):
$$5.8 \leq ( {I}_{p} \times ( {T}_{p} + {T}_{up} + {T}_{down} ) - ( {I}_{p} - {I}_{b} ) \times ( {T}_{up} + {T}_{down} ) / 2 ) / ( {T}_{p} + {T}_{u p} + {T}_{down} ) \times V / W / 10 \; 00 \leq 14.4 , \qquad ( 3 )$$
where Iₚ (A) is pulse peak current, I_{b} (A) is pulse base current, Tₚ (ms) is pulse peak time, Tᵤₚ (ms) is rise time, T_{down} (ms) is fall time, V (V) is arc voltage, and W (cm/s) is welding speed.
